(19) United States
(12) Patent Application Publication
(10) Pub. No.: US 2020/0166805 A1
(43) Pub. Date: May 28, 2020

(54) LIQUID CRYSTAL DISPLAY DEVICE AND METHOD FOR MANUFACTURING THE SAME

(71) Applicant: SAMSUNG DISPLAY CO., LTD., Yongin-si (KR)

(72) Inventors: Myung Hun BAEK, Yongin-si (KR); Jae Hwan JEON, Yongin-si (KR)

(21) Appl. No.: 16/655,381

(22) Filed: Oct. 17, 2019

(30) Foreign Application Priority Data
Nov. 27, 2018 (KR) 10-2018-0148643

(51) Int. Cl. G02F 1/1335

(52) U.S. Cl. CPC G02F 1/133606; G02F 1/133603; G02F 2001/133607; G02F 1/133524; G02F 1/133611

(57) ABSTRACT

A liquid crystal display (“LCD”) device includes a backlight unit including a reflective plate, a light guide plate, and an optical sheet, which are sequentially stacked therein; and an LCD panel disposed on the backlight unit, the LCD panel including a display area and a non-display area surrounding the display area. A plurality of alignment marks is marked in the display area on a top surface of at least one of the reflective plate, the light guide plate, the optical sheet, and the LCD panel.

The application claims priority to Korean patent application 10-2018-0148643, filed on Nov. 27, 2018, and all the benefits accruing therefrom under 35 U.S.C. § 119, the content of which in its entirety is herein incorporated by reference.

### BACKGROUND

### 1. Field

Exemplary embodiments of the invention generally relate to a liquid crystal display device and a method for manufacturing the same.

### 2. Description of the Related Art

A liquid crystal display (“LCD”) device allows light to be transmitted therethrough by controlling liquid crystal molecules aligned by an electric field generated between two electrodes in an LCD panel, and implements an image by the transmitted light. Also, the LCD device includes the display panel, a backlight unit for supplying light to the display panel, and the like.

### SUMMARY

Exemplary embodiments provide a liquid crystal display (“LCD”) and a method for manufacturing the same, in which a plurality of alignment marks is marked in a display area of several components included in the LCD device, so that the alignment accuracy of the several components of the LCD device may be improved, and the bezel size of the LCD device may be minimized.

Exemplary embodiments also provide an LCD and a method for manufacturing the same, in which a gap between a plurality of light sources and a light guide plate, which are included in the LCD device, is constantly maintained by marking a plurality alignment marks and an alignment line respectively on the plurality of light sources and the light guide plate.

According to an exemplary embodiment of the invention, there is provided an LCD device including a backlight unit including a reflective plate, a light guide plate, and an optical sheet, which are sequentially stacked therein, and an LCD panel disposed on the backlight unit, the LCD panel including a display area and a non-display area surrounding the display area, where a plurality of alignment marks is marked in the display area on a top surface of at least one of the reflective plate, the light guide plate, the optical sheet, and the LCD panel.

In an exemplary embodiment, a number of the plurality of alignment marks marked on the top surface of the at least one of the reflective plate, the light guide plate, the optical sheet, and the LCD panel may be four, and the plurality of alignment marks may be disposed adjacent to respective vertices of the top surface.

In an exemplary embodiment, a plurality of first alignment marks may be marked on a top surface of one of the reflective plate, the light guide plate, the optical sheet, and the LCD panel, and a plurality of second alignment marks may be marked on a top surface of another one of the reflective plate, the light guide plate, the optical sheet, and the LCD panel. Two diagonal lines connecting the plurality of first alignment lines and two diagonal lines connecting the plurality of second alignment lines may overlap with each other.

In an exemplary embodiment, an intersecting point of the two diagonal lines connecting the plurality of first alignment marks and an intersecting point of the two diagonal lines connecting the plurality of second alignment marks may overlap with each other.

In an exemplary embodiment, the plurality of alignment marks may include a fluorescent material.

In an exemplary embodiment, the plurality of alignment marks may be viewed by light having a wavelength of no less than about 10 nanometers (nm) and no more than about 400 nm.

In an exemplary embodiment, the thickness of each of the plurality of align marks may be about 20 micrometers (μm) or less.

In an exemplary embodiment, the LCD device may further include a light source unit disposed adjacent to a side surface of the light guide plate, the light source unit including a plurality of light sources. A gap alignment line may be marked along an edge of the top surface of the light guide plate, which is adjacent to the light source unit. A plurality of gap alignment marks may be respectively marked on top surfaces of the plurality of light sources.

In an exemplary embodiment, shortest distances between the respective gap alignment marks and the gap alignment line may be equal to each other.

In an exemplary embodiment, the LCD device may further include a lower cover surrounding bottom and side surfaces of the backlight unit, the lower cover including a top surface on which the plurality of alignment marks is marked in the display area, and an intermediate cover surrounding a portion of the top surface of the backlight unit and a side surface of the lower cover, the intermediate cover including a top surface on which the plurality of alignment marks is marked in the non-display area.

In an exemplary embodiment, edges of the reflective plate, the light guide plate, and the optical sheet may have a linear shape.

In an exemplary embodiment, the optical sheet may include a diffusion sheet, a prism sheet, and an external light reflection preventing sheet, which are sequentially stacked therein.

According to another exemplary embodiment of the invention, there is provided a method for manufacturing an LCD device, the method including detecting positions of diagonal lines connecting a plurality of first alignment marks marked in one of a reflective plate, a light guide plate, an optical sheet, and an LCD panel including a display area and a non-display area surrounding the display area, and positions of diagonal lines connecting a plurality of second alignment marks marked in another one of the reflective plate, the light guide plate, the optical sheet, and the LCD panel; aligning the one and the another one such that an intersecting point of the diagonal lines connecting the plurality of first alignment marks and an intersecting point of the diagonal lines connecting the plurality of second alignment marks overlap with each other; and adjusting degrees of inclination of the one and the another one such that the diagonal lines connecting the plurality of first alignment marks and the diagonal lines connecting the plurality of second alignment marks overlap with each other.

In an exemplary embodiment, each of the plurality of first alignment marks and the plurality of second alignment marks may be marked to overlap with the display area.

In an exemplary embodiment, the detecting the positions of the diagonal lines connecting the plurality of first alignment marks and the positions of the diagonal lines connecting the plurality of second alignment marks may include detecting positions of the plurality of first alignment marks of which a number is four, which are respectively disposed adjacent to four vertices of a top surface of the one; detecting positions of two diagonal lines connecting the plurality of first alignment marks, based on the positions of the plurality of first alignment marks; detecting positions of the plurality of second alignment marks of which a number is four, which are respectively disposed adjacent to four vertices of a top surface of the another one; and detecting positions of two diagonal lines connecting the plurality of second alignment marks, based on the positions of the plurality of second alignment marks.

In an exemplary embodiment, the plurality of first alignment marks and the plurality of second alignment marks may include a material that absorbs ultraviolet light and emits visible light.

In an exemplary embodiment, the method may further include detecting a gap alignment line marked along an edge of a top surface of the light guide plate, which is adjacent to a light source unit and a plurality of gap alignment marks respectively marked on top surfaces of a plurality of light sources of the light source unit; calculating a plurality of gap dimensions that are shortest distances between the respective gap alignment marks and the gap alignment line; and when the plurality of gap dimensions is different from each other, changing positions of the light guide plate and the light source unit such that the plurality of gap dimensions is equal to each other.

In an exemplary embodiment, the detecting the gap alignment line may be performed using a line scan camera.

In an exemplary embodiment, the method may further include forming a lower cover surrounding bottom and side surfaces of the reflective plate, the light guide plate, and the optical sheet, the lower cover including a surface on which the reflective plate is disposed (e.g., mounted), where a plurality of third alignment marks overlapping with the display area is marked on the surface; and forming an intermediate cover in contact with a portion of a top surface of the optical sheet and a side surface of the lower cover, the intermediate cover including a top surface on which a plurality of fourth alignment marks overlapping with the non-display area is marked.

### BRIEF DESCRIPTION OF THE DRAWINGS

Exemplary embodiments will now be described more fully hereinafter with reference to the accompanying drawings; however, they may be embodied in different forms and should not be construed as limited to the exemplary embodiments set forth herein. Rather, these embodiments are provided so that this invention will be thorough and complete, and will fully convey the scope of the exemplary embodiments to those skilled in the art.

In the drawing figures, dimensions may be exaggerated for clarity of illustration. It will be understood that when an element is referred to as being “between” two elements, it may be the only element between the two elements, or one or more intervening elements may also be present. Like reference numerals refer to like elements throughout.

FIG. 1 is an exploded perspective view illustrating an exemplary embodiment of a liquid crystal display (“LCD”) device according to the invention.

FIG. 2 is a cross-sectional view taken along line II-II′ of FIG. 1.

FIG. 3 is a flowchart illustrating an exemplary embodiment of a method for manufacturing the LCD device according to the invention.

FIGS. 4A to 4D are process plan views illustrating an exemplary embodiment of the LCD device and the method according to the invention.

FIGS. 5A and 5B are process plan views illustrating another exemplary embodiment of an LCD device and a method for manufacturing the same according to the invention.

### DETAILED DESCRIPTION

The effects and characteristics of the invention and a method of achieving the effects and characteristics will be clear by referring to the exemplary embodiments described below in detail together with the accompanying drawings. However, the invention is not limited to the exemplary embodiments disclosed herein but may be implemented in various forms. The exemplary embodiments are provided by way of example only so that a person of ordinary skilled in the art can fully understand the features in the invention and the scope thereof. Therefore, the invention can be defined by the scope of the appended claims.

The shapes, sizes, ratios, angles, numbers, and the like illustrated in the accompanying drawings for describing the various embodiments of the invention are merely examples, and the invention is not limited thereto. Like reference numerals generally denote like elements throughout the specification. Further, in the following description of the invention, a detailed explanation of known related technologies may be omitted to avoid unnecessarily obscuring the subject matter of the invention. The terms such as “including” and “comprising” used herein are generally intended to allow other components to be added unless the terms are used with the term “only.” Any references to singular may include plural unless expressly stated otherwise.

Components are interpreted to include an ordinary error range even when not expressly stated.

When the positional relationship between two parts is described using the terms such as “on,” “above,” “below,” and “next,” one or more parts may be positioned between the two parts unless the terms are used with the term “immediately” or “directly” is not used.

When an element or layer is disposed “on” other element or layer, another layer or another element may be interposed directly on the other element or therebetween. When it is described that a component is “connected” or “coupled” to another component, it is understood that the component is directly connected or coupled to the other component but another component is “interposed” between each component, or each component may be “connected” or “coupled” via another components.

Although the terms “first,” “second,” and the like are used for describing various components, these components are not confined by these terms. These terms are merely used for distinguishing one component from the other components. Therefore, a first component may be a second component or vice versa according to the technical concepts of the invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Respective characteristics of several exemplary embodiments of the invention may be partially or entirely coupled or combined, and technically and variously connected and driven enough for those skilled in the art to fully understand, and respective exemplary embodiments may be independently carried out, and implemented together according to an associated relation.

Hereinafter, exemplary embodiments of the invention will be described in more detail with reference to the accompanying drawings.

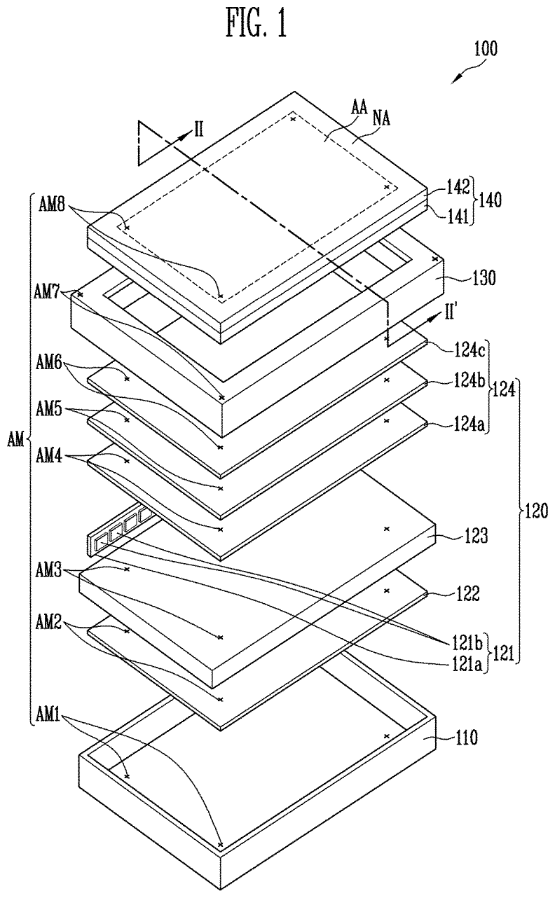

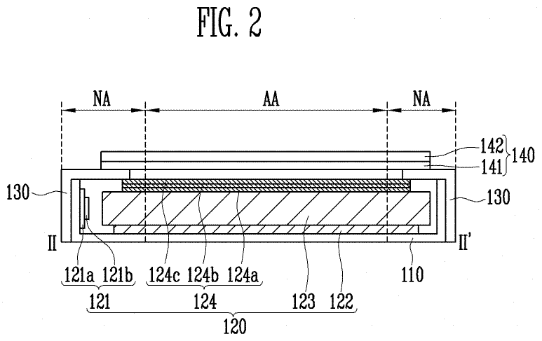

FIG. 1 is an exploded perspective view illustrating a liquid crystal display (“LCD”) device according to an exemplary embodiment of the invention. FIG. 2 is a cross-sectional view taken along line II-II′ of FIG. 1.

Referring to FIGS. 1 and 2, the LCD device 100 includes a lower cover 110, a backlight unit 120, an intermediate cover 130, and an LCD panel 140.

The LCD panel 140 is a component for displaying an image. The LCD panel 140 may include a first substrate 141, a second substrate 142, and a liquid crystal layer (not shown) disposed between the first substrate 141 and the second substrate 142. Specifically, the first substrate 141 of the LCD panel 140 is a thin film transistor (“TFT”) substrate, and includes a display area AA in which an image is displayed and a non-display area NA surrounding the display area AA. A plurality of pixels each of which is a minimum unit for emitting light may be defined in the display area AA. In an exemplary embodiment, the plurality of pixels may include a red pixel, a green pixel, and a blue pixel, for example. A TFT may be disposed in each of the plurality of pixels, and each of the TFTs may be connected to signal lines, i.e., a gate line and a data line.

Specifically, although not shown in FIGS. 1 and 2, a plurality of signal lines may be disposed in the display area AA of the first substrate 141. The plurality of signal lines may include a plurality of data lines and a plurality of gate lines. The plurality of data lines may extend in a first direction to transfer a data signal to each of the plurality of pixels, and the plurality of gate lines may extend in a second direction perpendicular to the first direction to transfer a gate signal to the plurality of pixels. The first and second directions may be perpendicular to each other, but the invention is not limited thereto.

The non-display area NA of the first substrate 141 is an area in which no image is displayed, and is an area surrounding the display area AA. Various components for driving the plurality of pixels disposed in the display area AA may be disposed in the non-display area NA. In an exemplary embodiment, a data driver and a gate driver may be disposed in the non-display area NA, and be bonded to a plurality of pads, for example. In addition, the plurality of pads may be electrically connected to the plurality of pixels through link lines, respectively. The data driver is a component for processing data for displaying image and a driving signal, and may be configured with a base film including an insulating material having flexibility and a driving integrated circuit (“IC”). In addition, the gate driver is a component for outputting a gate signal and sequentially supplying the gate signal to the plurality of pixels under the control of a timing controller, and may be configured with a base film and a driving IC. In an exemplary embodiment, the data driver and the gate driver may be disposed using mounting methods such as chip on glass (“COG”), chip on film (“COF”), and tape carrier package (“TCP”), but the invention is not limited thereto.

The second substrate 142 of the LCD panel 140 may be a color filter substrate. Specifically, the second substrate 142 may include a color filter and a common electrode. The color filter may be disposed on one surface of the substrate 142, and implement a specific color, using light provided from the backlight unit 120. In an exemplary embodiment, the color filter may have any one color among red, green, blue, cyan, magenta, and yellow, and be provided through a process such as deposition or coating. The color filter may be disposed on the second substrate 142, but the invention is not limited thereto. In an exemplary embodiment, the color filter may be disposed on the first substrate 141, for example. The common electrode disposed corresponding to a pixel electrode of the first substrate 141 may be disposed on the second substrate 142. However, the invention is not limited thereto, and the common electrode may be disposed on the first substrate 141.

The liquid crystal layer of the LCD panel 140 may be disposed between the first substrate 141 and the second substrate 142. The liquid crystal layer may include a plurality of liquid crystal molecules. The liquid crystal molecules may be arranged in a specific direction by an electric field generated by the pixel electrode and the common electrode. Thus, the transmittance of light provided from the backlight unit 120 may be adjusted by the liquid crystal.

In addition, although not shown in FIGS. 1 and 2, a polarizing layer may be disposed on an outer surface of the LCD panel 140, at least one of a bottom surface of the first substrate 141 and a top surface of the second substrate 142.

The backlight unit 120 is disposed under the LCD panel 140. The backlight unit 120 is a component for providing light to the LCD panel 140. The backlight unit 120 includes a reflective plate 122, a light source unit 121, a light guide plate 123, and an optical sheet 124.

Specifically, the light source unit 121 of the backlight unit 120 is a component for generating light. The light source unit 121 includes a plurality of light sources 121b and a printed circuit board 121a. The plurality of light sources 121b of the light source unit 121 may be implemented with a light emitting diode, and be disposed (e.g., mounted) on the printed circuit board 121a. The plurality of light sources 121b may all emit light of the same color. In an exemplary embodiment, the plurality of light sources 121b may emit white or blue light, for example. However, the invention is not limited thereto, and the plurality of light sources 121b may emit lights of different colors. In an exemplary embodiment, some of the plurality of light sources 121b emit red light, others of the plurality of light sources 121b may emit green light, and the others of the plurality of light sources 121b may emit blue light, for example.

The light guide plate 123 of the backlight unit 120 is a component for radiating light emitted from the light source unit 121 in the direction of the LCD panel 140. Specifically, the light source unit 121 may be disposed at one side of the light guide plate 123, and light emitted from the plurality of light sources 121b of the light source unit 121 may be incident onto a side surface of the light guide plate 123. The light guide plate 123 may radiate the incident light to a top surface of the light guide plate 123, and the radiated light may be incident onto the LCD panel 140.

Although a case where the light source unit 121 is disposed at the side surface of the light guide plate 123 to provide light to the side surface of the light guide plate 123 is described in this exemplary embodiment, the invention is not limited thereto. In an exemplary embodiment, the light source unit 121 may provide light in the lower direction of the light guide plate 123, for example. In another exemplary embodiment, the light guide plate 123 may be omitted from the backlight unit 120. The light source unit 121 may be disposed at a bottom surface of the LCD panel 140 to provide light directly to the LCD panel 140.

The reflective plate 122 of the backlight unit 120 is disposed on the bottom of the light guide plate 123. The reflective plate 122 is a component for changing the route of light that is not provided in the LCD panel 140 but is leaked in another direction among lights radiated from the light source unit 121 in the direction in which the LCD panel 140 by reflecting the light. The reflective plate 122 may include a material for reflecting light, and accordingly, the route of light incident onto the reflective plate 122 may be changed in the direction in which the LCD panel 140 is disposed by reflecting the light. Thus, the amount of light provided to the LCD panel 140 may be increased.

The optical sheet 124 of the backlight unit 120 is disposed between the light guide plate 123 and the LCD panel 140. The optical sheet 124 is a component for controlling light radiated in the direction in which the optical sheet 124 is disposed from the light guide plate 123. Specifically, the optical sheet 124 includes a diffusion sheet 124a, a prism sheet 124b, and an external light reflection preventing sheet 124c. The diffusion sheet 124a is a component for diffusing light emitted from the light guide plate 123. The prism sheet 124b is a component for condensing light emitted from the diffusion sheet 124a in a direction perpendicular to the bottom surface of the LCD panel 140, i.e., a direction toward the LCD panel 140. Accordingly, light transmitted through the prism sheet 124b may be perpendicularly incident onto the LCD panel 140. In addition, the external light reflection preventing sheet 124c is a component for preventing external light incident into the LCD device 100 from the outside of the LCD device 100 from being reflected in the LCD device 100 to be again emitted to the outside. Accordingly, an external light reflection phenomenon may be prevented, in which external objects are viewed on a surface of the LCD device 100.

Although a case where the optical sheet 124 includes the diffusion sheet 124a, the prism sheet 124b, and the external light reflection preventing sheet 124c is described in this exemplary embodiment, the invention is not limited thereto. In an exemplary embodiment, the optical sheet 124 may include various components such as a protective sheet for protecting the prism sheet 124b from external impact, and any component among the various components may be omitted. In addition, the components included in the optical sheet 124 may be disposed in a structure in which a plurality of layers instead of one layer are stacked.

The lower cover 110 of the LCD device 100 is a component for accommodating the backlight unit 120 and supporting the backlight unit 120 and the LCD panel 140. A space for accommodating the backlight unit 120 may be defined in the lower cover 110 to surround the backlight unit 120, and the lower cover 110 may be disposed to correspond to bottom and side surfaces of the backlight unit 120.

Accordingly, the backlight unit 120 is accommodated in the internal accommodating space of the lower cover 110, to be supported by the lower cover 110.

The intermediate cover 130 of the LCD device 100 is a component for protecting the backlight unit 120 and the lower cover 110 while surrounding the backlight unit 120 and the lower cover 110. The intermediate cover 130 may surround a portion of a top surface of the backlight unit 120, i.e., a portion of the top surface of the backlight unit 120, which is adjacent to edges, and surround a side surface of the lower cover 110. Accordingly, the backlight unit 120 may be effectively protected by the lower cover 110 and the intermediate cover 130. In addition, a portion of a top surface of the intermediate cover 130 may be adhered to the LCD panel 140, and accordingly, the LCD panel 140 and the backlight unit 120 may be firmly attached by the intermediate cover 130 and the lower cover 110.

A plurality of alignment marks AM may be marked on several components of the LCD device 100. The plurality of alignment marks AM is used to align the several components of the LCD device 100 in a manufacturing process of the LCD device 100. The plurality of alignment marks AM may be marked on top surfaces of the several components of the LCD device 100, and the several components are aligned and coupled to each other by the plurality of alignment marks AM, so that the LCD device 100 may be manufactured.

Specifically, a plurality of first alignment marks AM1 may be marked on the lower cover 110 of the LCD device 100. The plurality of first alignment marks AM1 may be marked on a surface of the lower cover 110, on which the reflective plate 122 is disposed (e.g., mounted).

A plurality of second alignment marks AM2 may be marked on a top surface of the reflective plate 122 of the backlight unit 120, and a plurality of third alignment marks AM3 may be marked on the top surface of the light guide plate 123. In addition, a plurality of fourth alignment marks AM4, a plurality of fifth alignment marks AM5, and a plurality of sixth alignment marks AM6 may be respectively marked on the diffusion sheet 124a, the prism sheet 124b, and the external light reflection preventing sheet 124c, which constitute the optical sheet 124.

A plurality of seventh alignment marks AM7 may be marked on the intermediate cover 130 of the LCD device 100. The plurality of seventh alignment marks AM7 may be marked on the top surface of the intermediate cover 130, i.e., a surface in contact with the LCD panel 140.

A plurality of eighth alignment marks AM8 may be marked on a top surface of the LCD panel 140 of the LCD device 100, i.e., the top surface of the second substrate 142 of the LCD panel 140.

Some of the plurality of alignment marks AM marked on the components of the LCD device 100 may be marked in the display area AA of the LCD device 100. Specifically, as described above, the LCD panel 140 includes the display area AA and the non-display area NA surrounding the display area AA. The plurality of alignment marks AM marked on the top surface of each of the components of the LCD device 100 may be marked on the component to overlap with the display area AA. In an exemplary embodiment, the plurality of first alignment marks AM1 marked on the top surface of the lower cover 110 may be marked in the display area AA, i.e., to overlap with the display area AA of the LCD panel 140, for example. In addition, each of the plurality of second alignment marks AM2 to the plurality of sixth alignment marks AM6, which are respectively marked on the reflective plate 122, the light guide plate 123, the diffusion sheet 124a, the prism sheet 124b, and the external light reflection preventing sheet 124c, may be marked in the display area AA, i.e., to overlap with the display area AA. In addition, the plurality of eighth alignment marks AM8 marked on the top surface of the LCD panel 140, i.e., the top surface of the second substrate 142 may be marked in the display area AA of the LCD panel 140.

The plurality of seventh alignment marks AM7 marked on the top surface of the intermediate cover 130 of the LCD device 100 may be marked in the non-display area NA, i.e., to overlap with the non-display area NA of the LCD panel 140. Unlike other components of the LCD device 100, the intermediate cover 130 may not overlap with the display area AA of the LCD device 100. Accordingly, the plurality of seventh alignment marks AM7 marked on the top surface of the intermediate cover 130 that is a component not overlapping with the display area AA of the LCD device 100 may be marked in the non-display area NA of the LCD device 100.

In the case of a component overlapping with the display area AA among the components of the LCD device 100, the plurality of alignment marks AM marked on the top surface of the component may be marked in the display area AA. Also, in the case of a component that has no portion overlapping with the display area AA and includes only a portion overlapping with the non-display area NA among the components of the LCD device 100, the plurality of alignment marks AM of the component may be marked in the non-display area NA.

The plurality of alignment marks AM marked on each of the several components of the LCD device 100 may be disposed adjacent to vertices of the top surface of the component. In an exemplary embodiment, the top surface of a component on which a plurality of alignment marks AM is marked may be provided in a rectangular shape, and have four vertices, for example. The number of the plurality of alignment marks AM may be four, and be marked adjacent to the four vertices. In an exemplary embodiment, the number of the plurality of eighth align marks AM8 marked on the top surface of the LCD panel 140 may be four, and be marked at end portions of two diagonal lines of the top surface of the LCD panel 140 to be adjacent to four vertices of the top surface, for example. Accordingly, an intersecting point of the two diagonal lines connecting the plurality of eighth alignment marks AM8 marked on the top surface of the LCD panel 140 may be adjacent to the center of the top surface of the LCD panel 140.

The shape of the plurality of alignment marks AM may be a cross shape (+) as shown in FIG. 1. However, the invention is not limited thereto, and the plurality of alignment marks AM may have various shapes, when necessary. In an exemplary embodiment, the plurality of alignment marks AM may have a point shape or a ‘¬’ shape disposed along an edge of the top surface, for example.

The plurality of alignment marks AM may include a fluorescent material.

The fluorescent material is a material that reacts with ultraviolet light, and is a material that absorbs ultraviolet light and emits visible light. Specifically, the plurality of alignment marks AM may be viewed by light having a wavelength of no less than about 10 nanometers (nm) and no more than about 400 nm, for example. That is, the plurality of alignment marks AM may absorb light in a wavelength band of no less than about 10 nm and no more less than about 400 nm, for example, and emit visible light. Accordingly, the plurality of alignment marks AM is not viewed by eyes of a user in a situation in which the LCD device 100 generally displays an image.

In an exemplary embodiment, the thickness of the plurality of alignment marks AM may be about 20 micrometers (μm) or less, for example. When the thickness of the plurality of alignment marks AM is about 20 μm or more, the plurality of alignment marks AM may be viewed by the eyes of the user. Thus, the thickness of the plurality of alignment marks AM is provided to about 20 μm or less, so that the probability that the plurality of alignment marks AM will be viewed by the eyes of the user may be reduced.

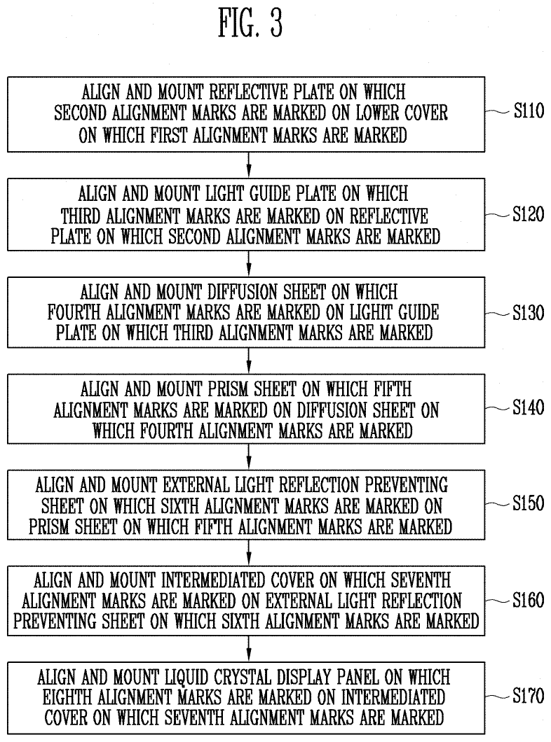

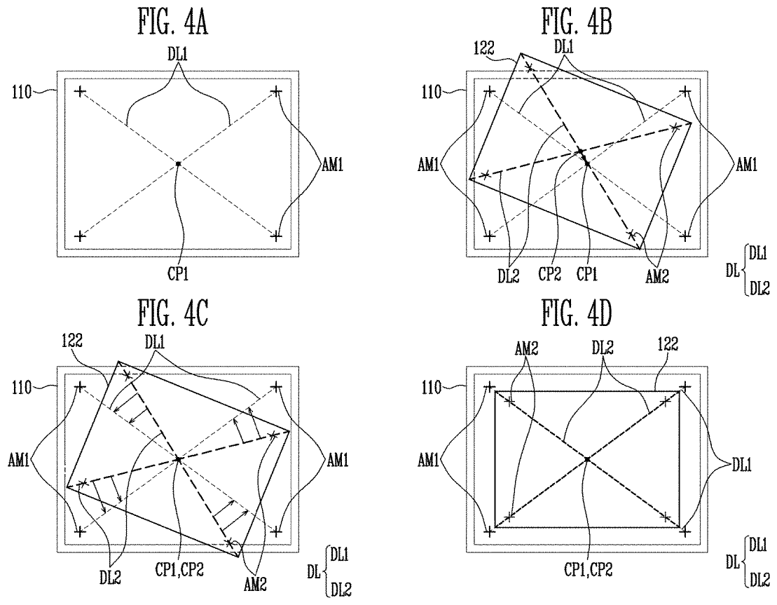

FIG. 3 is a flowchart illustrating an exemplary embodiment of a method for manufacturing the LCD device according to the invention. FIGS. 4A to 4D are process plan views illustrating the exemplary embodiment of the LCD device and the method according to the invention.

Referring to FIGS. 3 and 4A, first, the lower cover 110 is disposed on a supporting member. Although not shown in FIG. 4A, the lower cover 110 may be moved onto the supporting member for supporting several components of the LCD device 100 in a manufacturing process of the LCD device 100 to be disposed on the supporting member.

Subsequently, although not shown in FIG. 4A, the light source unit 121 may be disposed (e.g., mounted) on an inner surface of the lower cover 110. Specifically, the light source unit 121 may include the printed circuit board 121a and the plurality of light sources 121b disposed side by side on the printed circuit board 121a. The light source unit 121 may be attached to one of inner surfaces of the lower cover 110.

Subsequently, the reflective plate 122 on which the plurality of second alignment marks AM2 is marked may be aligned and disposed (e.g., mounted) on the lower cover 110 on which the plurality of first alignment marks AM1 is marked (S110).

Specifically, positions of the plurality of first alignment marks AM1 marked on the lower cover 110 are detected. A scan camera may be disposed above the supporting member. The scan camera may detect the positions of the plurality of first alignment marks AM1 marked on the top surface of the lower cover 110 disposed (e.g., mounted) on the supporting member. The number of scan cameras may be changed depending on the number of the plurality of first alignment marks AM1. When the number of the plurality of first alignment marks AM1 is four, the number of scan cameras may be four. The plurality of scan cameras may be located above the plurality of first alignment marks AM1 to recognize the plurality of first alignment marks AM1, respectively. However, the number of scan cameras is not limited thereto. In addition, when the plurality of first alignment marks AM1 includes a fluorescent material, the scan camera may be an ultraviolet camera capable of recognizing the fluorescent material.

Subsequently, positions of two diagonal lines DL connecting the plurality of first alignment marks AM1 may be detected based on the positions of the plurality of first alignment marks AM1, which are detected by the scan camera. The plurality of first alignment marks AM1 may be marked adjacent to four vertices of the top surface of the lower cover 110, and accordingly, the two diagonal lines DL connecting the plurality of first alignment marks AM1 may be first diagonal lines DL1 as shown in FIG. 4A. Therefore, positions of the first diagonal lines DL1 connecting two pairs of alignment marks facing each other in diagonal directions among the plurality of first alignment marks AM1 may be detected based on the positions of the plurality of first alignment marks AM1.

An intersecting point of the first diagonal lines DL1 connecting the plurality of first alignment marks AM1 may be detected based on the positions of the first diagonal lines DL1. The intersecting point of the two diagonal lines connecting the plurality of first alignment marks AM1 may be a first intersecting point CP1, and the first intersecting point CP1 may be detected based on the positions of the first diagonal lines DL1.

Subsequently, referring to FIG. 4B, the reflective plate 122 may be aligned on the lower cover 110. The reflective plate 122 may be moved to the top of the lower cover 110, to be aligned at an accurate position on the lower cover 110. Specifically, positions of the plurality of second alignment marks AM2 marked on the reflective plate 122 are detected. The plurality of second alignment marks AM2 may be disposed adjacent to four vertices on the top surface of the reflective plate 122, and the positions of the plurality of second alignment marks AM2 may be detected by the scan camera disposed above the supporting member. The scan camera is an ultraviolet camera, and may recognize the plurality of second alignment marks AM2.

Positions of two diagonal lines connecting the plurality of second alignment marks AM2 may be detected based on the positions of the plurality of second alignment marks AM2, which are detected by the scan camera. The two diagonal lines connecting the plurality of second alignment marks AM2 may be second diagonal lines DL2 as shown in FIG. 4B. Therefore, positions of the second diagonal lines DL2 connecting two pairs of alignment marks facing each other in diagonal directions among the plurality of second alignment marks AM2 may be detected based on the positions of the plurality of second alignment marks AM2.

An intersecting point of the second diagonal lines DL2 connecting the plurality of second alignment marks AM2 may be detected based on the positions of the second diagonal lines DL2. The intersecting point of the two diagonal lines connecting the plurality of second alignment marks AM2 may be a second intersecting point CP2, and the second intersecting point CP2 may be detected based on the positions of the second diagonal lines DL2.

Subsequently, as shown in FIG. 4B, the reflective plate 122 may be aligned such that the second intersecting point CP2 overlaps with the first intersecting point CP1 on the top of the first intersecting point CP1. Accordingly, the reflective plate 122 may be moved on the lower cover 110 such that the intersecting point CP2 of the diagonal lines of the plurality of second alignment marks AM2 overlaps with the intersecting point CP1 of the diagonal lines of the plurality of first alignment marks AM1.

Subsequently, referring to FIG. 4C, the slope of the reflective plate 122 may be adjusted. Specifically, the reflective plate 122 may be rotated with reference to the second intersecting point CP2 while maintaining a state in which the second intersecting point CP2 overlaps with the first intersecting point CP1. Accordingly, the degree of inclination of the reflective plate 122 with respect to the lower cover 110 is adjusted, so that the reflective plate 122 and the lower cover 110 may be aligned. The reflective plate 122 may be rotated such that the second diagonal lines DL2 that are diagonal lines of the plurality of second alignment marks AM2 marked on the reflective plate 122 overlap with the first diagonal lines DL1 that are diagonal lines of the plurality of first alignment marks AM1 marked on the lower cover 110.

When the degree of inclination of the reflective plate 122 is adjusted, the second diagonal lines DL2 that are diagonal lines connecting the plurality of second alignment marks AM2 marked on the reflective plate 122 and the first diagonal lines DL1 that are diagonal lines connecting the plurality of first alignment marks AM1 marked on the lower cover 110 may overlap with each other as shown in FIG. 4D. Subsequently, the reflective plate 122 aligned on the lower cover 110 may be disposed (e.g., mounted) on the lower cover 110.

Subsequently, the light guide plate 123 on which the plurality of third alignment marks AM3 is marked may be aligned and disposed (e.g., mounted) on the reflective plate 122 on which the plurality of second alignment marks AM2 is marked (S120). Specifically, the light guide plate 123 may be moved to the top of the reflective plate 122, and positions of the plurality of third alignment marks AM3 may be detected by the scan camera. Positions of two diagonal lines connecting the plurality of third alignment marks AM3 and an intersecting point of the two diagonal lines may be detected based on the detected positions of the plurality of third alignment marks AM3. Subsequently, the light guide plate 123 may be moved such that the intersecting point of the two diagonal lines connecting the plurality of third alignment marks AM3 and the intersecting point of the two diagonal lines connecting the plurality of second alignment marks AM2 marked on the reflective plate 122 overlap with each other. Subsequently, the light guide plate 123 may be rotated with reference to the intersecting point of the two diagonal lines connecting the plurality of third alignment marks AM3 such that the two diagonal lines connecting the plurality of third alignment marks AM3 and the two diagonal lines connecting the plurality of second alignment marks AM2 marked on the reflective plates 122 overlap with each other. Thus, the degree of inclination of the light guide plate 123 may be adjusted. Accordingly, the light guide plate 123 may be accurately aligned on the reflective plate 122, and the aligned light guide plate 123 may be disposed (e.g., mounted) on the reflective plate 122.

Subsequently, the diffusion sheet 124A on which the plurality of fourth alignment marks AM4 is marked may be aligned and disposed (e.g., mounted) on the light guide plate 123 on which the plurality of third alignment marks AM3 is marked (S130). Specifically, the diffusion sheet 124a may be moved to the top of the light guide plate 123, and positions of the plurality of fourth alignment marks AM4 marked on the diffusion sheet 124a may be detected by the scan camera. Positions of two diagonal lines connecting the plurality of fourth alignment marks AM4 and an intersecting point of the two diagonal lines may be detected based on the detected positions of the plurality of fourth alignment marks AM4. Subsequently, the diffusion sheet 124a may be moved such that the intersecting point of the two diagonal lines connecting the plurality of fourth alignment marks AM4 and the intersecting point of the two diagonal lines connecting the plurality of third alignment marks AM3 marked on the light guide plate 123 overlap with each other. Subsequently, the diffusion sheet 124a may be rotated with reference to the intersecting point of the two diagonal lines connecting the plurality of fourth alignment marks AM4 such that the two diagonal lines connecting the plurality of fourth alignment marks AM4 and the two diagonal lines connecting the plurality of third alignment marks AM3 marked on the light guide plate 123 overlap with each other. Thus, the degree of inclination of the diffusion sheet 124a may be adjusted. Accordingly, the diffusion sheet 124a may be accurately aligned on the light guide plate 123, and the aligned diffusion sheet 124a may be disposed (e.g., mounted) on the light guide plate 123.

Subsequently, the prism sheet 124b on which the plurality of fifth alignment marks AM5 is marked may be aligned and disposed (e.g., mounted) on the diffusion sheet 124a on which the plurality of fourth alignment marks AM4 is marked (S140). Specifically, the prism sheet 124b may be moved to the top of the diffusion sheet 124a, and positions of the plurality of fifth alignment marks AM5 marked on the prism sheet 124b may be detected by the scan camera. Positions of two diagonal lines connecting the plurality of fifth alignment marks AM5 and an intersecting point of the two diagonal lines may be detected based on the detected positions of the plurality of fifth alignment marks AM5. Subsequently, the prism sheet 124b may be moved such that the intersecting point of the two diagonal lines connecting the plurality of fifth alignment marks AM5 and the intersecting point of the two diagonal lines connecting the plurality of fourth alignment marks AM4 marked on the diffusion sheet 124a overlap with each other. Subsequently, the prism sheet 124b may be rotated with reference to the intersecting point of the two diagonal lines connecting the plurality of fifth alignment marks AM5 such that the two diagonal lines connecting the plurality of fifth alignment marks AM5 and the two diagonal lines connecting the plurality of fourth alignment marks AM4 marked on the diffusion sheet 124a overlap with each other. Thus, the degree of inclination of the prism sheet 124b may be adjusted. Accordingly, the prism sheet 124b may be accurately aligned on the diffusion sheet 124a, and the aligned prism sheet 124b may be disposed (e.g., mounted) on the diffusion sheet 124a.

Subsequently, the external light reflection preventing sheet 124c on which the plurality of sixth alignment marks AM6 is marked may be aligned and disposed (e.g., mounted) on the prism sheet 124b on which the plurality of fifth alignment marks AM5 is marked (S150). Specifically, the external light reflection preventing sheet 124c may be moved to the top of the prism sheet 124b, and positions of the plurality of sixth alignment marks AM6 marked on the external light reflection preventing sheet 124c may be detected by the scan camera. Positions of two diagonal lines connecting the plurality of sixth alignment marks AM6 and an intersecting point of the two diagonal lines may be detected based on the detected positions of the plurality of sixth alignment marks AM6. Subsequently, the external light reflection preventing sheet 124c may be moved such that the intersecting point of the two diagonal lines connecting the plurality of sixth alignment marks AM6 and the intersecting point of the two diagonal lines connecting the plurality of fifth alignment marks AM5 marked on the prism sheet 124b overlap with each other. Subsequently, the external light reflection preventing sheet 124c may be rotated with reference to the intersecting point of the two diagonal lines connecting the plurality of sixth alignment marks AM6 such that the two diagonal lines connecting the plurality of sixth alignment marks AM6 and the two diagonal lines connecting the plurality of fifth alignment marks AM5 marked on the prism sheet 124b overlap with each other. Thus, the degree of inclination of the external light reflection preventing sheet 124c may be adjusted. Accordingly, the external light reflection preventing sheet 124c may be accurately aligned on the prism sheet 124b, and the aligned external light reflection preventing sheet 124c may be disposed (e.g., mounted) on the prism sheet 124b.

Subsequently, the intermediate cover 130 on which the plurality of seventh alignment marks AM7 is marked may be aligned and disposed (e.g., mounted) on the external light reflection preventing sheet 124c on which the plurality of sixth alignment marks AM6 is marked (S160). Specifically, the intermediate cover 130 may be moved to the top of the external light reflection preventing sheet 124c, and positions of the plurality of seventh alignment marks AM7 marked on the intermediate cover 130 may be detected by the scan camera. Positions of two diagonal lines connecting the plurality of seventh alignment marks AM7 and an intersecting point of the two diagonal lines may be detected based on the detected positions of the plurality of seventh alignment marks AM7. Subsequently, the intermediate cover 130 may be moved such that the intersecting point of the two diagonal lines connecting the plurality of seventh alignment marks AM7 and the intersecting point of the two diagonal lines connecting the plurality of sixth alignment marks AM6 marked on the external light reflection preventing sheet 124c overlap with each other. Subsequently, the intermediate cover 130 may be rotated with reference to the intersecting point of the two diagonal lines connecting the plurality of seventh alignment marks AM7 such that the two diagonal lines connecting the plurality of seventh alignment marks AM7 and the two diagonal lines connecting the plurality of sixth alignment marks AM6 marked on the external light reflection preventing sheet 124c overlap with each other. Thus, the degree of inclination of the intermediate cover 130 may be adjusted. Accordingly, the intermediate cover 130 may be accurately aligned on the external light reflection preventing sheet 124c, and the aligned intermediate cover 130 may be disposed (e.g., mounted) on the external light reflection preventing sheet 124c.

Subsequently, the LCD panel 140 on which the plurality of eighth alignment marks AM8 is marked may be aligned and disposed (e.g., mounted) on the intermediate cover 130 on which the plurality of seventh alignment marks AM7 are marked (S170). Specifically, the LCD panel 140 may be moved to the top of the intermediate cover 130, and positions of the plurality of eighth alignment marks AM8 marked on the LCD panel 140 may be detected by the scan camera. Positions of two diagonal lines connecting the plurality of eighth alignment marks AM8 and an intersecting point of the two diagonal lines may be detected based on the detected positions of the plurality of eighth alignment marks AM8. Subsequently, the LCD panel 140 may be moved such that the intersecting point of the two diagonal lines connecting the plurality of eighth alignment marks AM8 and the intersecting point of the two diagonal lines connecting the plurality of seventh alignment marks AM7 marked on the intermediate cover 130 overlap with each other. Subsequently, the LCD panel 140 may be rotated with reference to the intersecting point of the two diagonal lines connecting the plurality of eighth alignment marks AM8 such that the two diagonal lines connecting the plurality of eighth alignment marks AM8 and the two diagonal lines connecting the plurality of seventh alignment marks AM7 marked on the intermediate cover 130 overlap with each other. Thus, the degree of inclination of the LCD panel 140 may be adjusted. Accordingly, the LCD panel 140 may be accurately aligned on the intermediate cover 130, and the aligned LCD panel 140 may be disposed (e.g., mounted) on the intermediate cover 130.

Each of the operations S120 to S170 of mounting the light guide plate 123, the diffusion sheet 124a, the prism sheet 124b, the external light reflection preventing sheet 124c, the intermediate cover 130, and the LCD panel 140 may be performed in the same manner as the operation S110 of mounting the reflective plate 122 on the lower cover 110, which is described in FIGS. 4A to 4D.

In an LCD device and a method for manufacturing the same according to a conventional art, alignment marks used to accurately align several components of the LCD device in a manufacturing process of the LCD device are not marked on the components of the LCD device. In addition, fastening parts having a shape protruding to the outside are provided at the periphery of a reflective plate, a light guide plate, an optical sheet, and the like, which constitute a backlight unit. In addition, the fastening parts are fitted into holes defined in a lower cover, an intermediate cover, and the like, and accordingly, the components of the backlight unit, the lower cover, and the intermediate cover may be aligned with each other by the fastening parts and the holes. The alignment and assembling of the several components of the LCD device are manually performed, and cannot be performed through an automated process. Therefore, the time desired to perform the manufacturing process of the LCD device may be increased. When the several components of the LCD device are aligned and assembled by the fastening parts and the holes, the alignment of the several components of the LCD device may not be accurately performed, and accordingly, the alignment accuracy and reliability of the LCD device may be deteriorated. Moreover, the size of a non-display area, i.e., the bezel size of the LCD device, in which the fastening parts and the holes defined in the several components of the LCD device are provided, may be increased.

In the LCD device 100 and the method according to the exemplary embodiment of the invention, the plurality of alignment marks AM may be marked on the top surfaces of the components of the backlight unit 120, the lower cover 110, the intermediate cover 130, and the LCD panel 140, and the alignment of the several components of the LCD device 100 may be performed using the plurality of alignment marks AM. Accordingly, the alignment and assembling of the several components of the LCD device 100 may be performed without using a fastening structure. That is, edges of the reflective plate 122, the light guide plate 123, and the optical sheet 124 of the LCD device 100 have a linear shape having no fastening structure. Thus, the method may be performed through an automated process without manually performing the alignment and assembling. Accordingly, the time and cost desired to perform the manufacturing process of the LCD device 100 may be reduced, and the alignment accuracy and reliability of the several components of the LCD device 100 may be improved.

In the LCD device 100 and the method according to the exemplary embodiment of the invention, the plurality of alignment marks AM may be marked in the display area AA of the several components of the LCD device 100. That is, the plurality of alignment marks AM overlaps with the display area AA of the LCD panel 140, to be marked on the top surfaces of the several components of the LCD device 100. In an exemplary embodiment, the plurality of alignment marks AM marked on the reflective plate 122, the light guide plate 123, and the optical sheet 124, which are included in the backlight unit 120, the lower cover 110, and the LCD panel 140 are marked in the display area AA. Accordingly, a separate area for marking a plurality of alignment marks is not provided in the non-display area NA of the LCD device 100, and the area of the non-display area NA, i.e., the bezel size of the LCD device 100 may be reduced.

In the LCD device 100 and the method according to the exemplary embodiment of the invention, the plurality of alignment marks AM marked in the display area AA of the several components of the LCD device 100 may include a fluorescent material. The fluorescent material is a material viewed by eyes of a user, using strong ultraviolet light, and hence the plurality of alignment marks AM marked in the display area AA of the LCD device 100 is not viewed by the eyes of the user of the LCD device 100.

In the LCD device 100 and the method according to the exemplary embodiment of the invention, the thickness of the plurality of alignment marks AM marked in the display area AA of the several components of the LCD device 100 is provided to about 20 μm or less, and accordingly, the plurality of alignment marks AM is not viewed by the eyes of the user of the LCD device 100.

In the LCD device 100 and the method according to the exemplary embodiment of the invention, the several components of the LCD device 100 are aligned with each other such that, in the plurality of alignment marks AM marked on each of the several components of the LCD device 100, two diagonal lines connecting the plurality of alignment marks AM overlap with each other, and intersecting points of the two diagonal lines overlap with each other. Specifically, positions of the plurality of first alignment marks AM1 and positions of two diagonal lines connecting the plurality of first alignment marks AM1 are detected, and positions of the plurality of second alignment marks AM2 and positions of two diagonal lines connecting the plurality of second alignment marks AM2 are detected. In addition, the position of a component is adjusted such that an intersecting point of the two diagonal lines connecting the plurality of first alignment marks AM1 and an intersecting point of the two diagonal lines connecting the plurality of second alignment marks AM2 overlap with each other. Subsequently, the degree of inclination of the component is adjusted such that the two diagonal lines overlap with each other while maintaining the state in which the intersecting points overlap with each other. Accordingly, the two diagonal lines connecting the plurality of first alignment marks AM1 and the two diagonal lines connecting the plurality of second alignment marks AM2 may completely overlap with each other. Thus, the several components of the LCD device 100 may be accurately aligned such that the intersecting points of the two diagonal lines overlap with each other, and the slope of the component may be minutely adjusted in the state in which the intersecting points of the two diagonal lines overlap with each other. Accordingly, the positions and slopes of the several components of the LCD device 100 may be minutely adjusted, and the alignment of the several components of the LCD device 100 may be accurately performed. Thus, the alignment accuracy and reliability of the LCD device 100 may be improved.

In the LCD device 100 and the method according to the exemplary embodiment of the invention, in the plurality of alignment marks AM marked on each of the several components of the LCD device 100, two diagonal lines connecting the plurality of alignment marks AM merely overlap with each other, and the plurality of alignment marks AM marked on one layer may not overlap with the plurality of alignment marks AM marked on another layer different from the one layer. In an exemplary embodiment, the plurality of alignment marks AM marked on the top surface of the lower cover 110 and the plurality of alignment marks AM marked on the top surface any one component of the backlight unit 120 may not overlap with each other, for example. However, two diagonal lines connecting the plurality of alignment marks AM may overlap with each other. Thus, the bezel size of each of the several components of the LCD device 100 is not adjusted such that the plurality of alignment marks AM marked on one layer overlaps with the plurality of alignment marks AM marked on another layer different from the one layer, and the bezel size of the LCD device 100 may be decreased. Further, the degree of freedom of designing the plurality of alignment marks AM marked on the several components of the LCD device 100 may be increased.

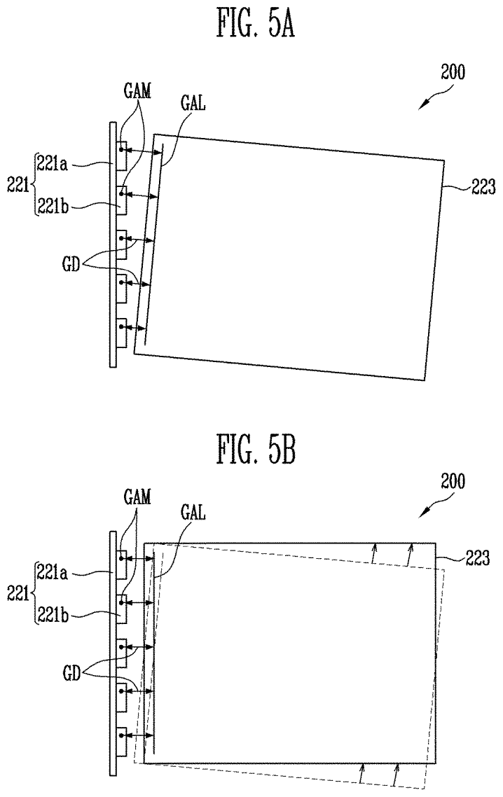

FIGS. 5A and 5B are process plan views illustrating another exemplary embodiment of an LCD device and a method for manufacturing the same according to the invention. The LCD device 200 and the method, which are shown in FIGS. 5A and 5B, are substantially identical to the LCD device 100 and the method, which are shown in FIGS. 1 to 4D, except a light source unit 221 and a light guide plate 223, and an aligning method of the light source unit 221 and the light guide plate 223, and therefore, overlapping descriptions will be omitted. In addition, the LCD device 200 shown in FIGS. 5A and 5B illustrates only the light source unit 221 and the light guide plate 223, and illustration of the other components will be omitted.

Referring to FIG. 5A, the light source unit 221 includes a printed circuit board 221a and a plurality of light sources 221b. A plurality of gap alignment marks GAM may be marked on top surfaces of the plurality of light sources 221b of the light source unit 221. The plurality of gap alignment marks GAM is used to align between the plurality of light sources 221b and the light guide plate 223 by adjusting a spaced distance between each of the plurality of light sources 221b and the light guide plate 223. The plurality of gap alignment marks GAM may be marked on the top surfaces of the plurality of light sources 221b. In an exemplary embodiment, as shown in FIG. 5A, the gap alignment mark GAM may be marked in shape of a point adjacent to one vertex of the top surface of each of the plurality of light sources 221b, for example. However, the shape and marked position of the gap alignment mark GAM are not limited thereto. In an exemplary embodiment, the gap alignment mark GAM may be marked in the shape of a point at the center of the top surface of each of the plurality of light sources 221b, and be marked at an edge of the top surface of each of the plurality of light sources 221b, which is adjacent to the light guide plate 223, for example.

A gap alignment line GAL may be marked on a top surface of the light guide plate 223. The gap alignment line GAL is a mark used to align positions of each of the plurality of light sources 221b and the light guide plate 223. The gap alignment line GAL may be disposed adjacent to an edge of the light guide plate 223, which is adjacent to the light source unit 221, along the edge of the light guide plate 223, and be marked in the shape of a line. However, the shape of the gap alignment line GAL is not limited thereto.

An aligning method of the light source unit 221 and the light guide plate 223 will be described. In the aligning method of the light source unit 221 and the light guide plate 223, the light source unit 221 may be attached to a sidewall of the lower cover 110 as described above. Subsequently, positions of the plurality of gap alignment marks GAM marked on the plurality of light sources 221b may be detected by a scan camera. The plurality of gap alignment marks GAM may include a fluorescent material, and the scan camera may be an ultraviolet camera capable of recognizing the fluorescent material. Also, the scan camera may be a line scan camera capable of moving along the top of each of the plurality of light sources 221b on the plurality of light sources 221b. Accordingly, the positions of the plurality of gap alignment marks GAM may be sequentially recognized when the line scan camera is moved.

Subsequently, a position of the gap alignment line GAL marked on the light guide plate 223 may be detected by the scan camera. The gap alignment line GAL may include a fluorescent material, and be recognized from one end to the other end thereof by the line scan camera that is an ultraviolet camera. After the positions of the plurality of gap alignment marks GAM are recognized by the scan camera, the position of the gap alignment line GAL may be recognized by the scan camera. However, the invention is not limited thereto, and the positions of the plurality of gap alignment marks GAM and the position of the gap alignment line GAL may be simultaneously detected through one-time movement of the line scan camera.

Subsequently, a plurality of gap dimensions GD that are shortest distances between the respective gap alignment marks GAM and the gap alignment line GAL may be calculated. Specifically, the shortest distances from the respective gap alignment marks GAM to the gap alignment line GAL may be calculated based on the detected positions of the plurality of gap alignment marks GAM and the detected position of the gap alignment line GAL. The shortest distances from the respective gap alignment marks GAM to the gap alignment line GAL may be calculated as the gap dimensions GD.

Subsequently, it may be determined whether the plurality of gap dimensions GD is equal to each other. When the extending direction of the light source unit 221 and the direction one surface of the light guide plate 223, which is adjacent to the light source unit 221, are not parallel to each other, the direction in which the plurality of gap alignment marks GAM is disposed in a line and the extending direction of the gap alignment line GAL may not be parallel to each other. In an exemplary embodiment, a gap dimension GD located at an upper portion on the plan view among the plurality of gap dimensions GD may be larger than that GD located at a lower portion on the plan view, for example. Therefore, it may be determined that the plurality of gap dimensions GD is not equal to each other.

Subsequently, referring to FIG. 5B, when the plurality of gap dimensions GD is different from each other, the positions of the light guide plate 223 and the light source unit 221 may be changed such that the plurality of gap dimensions GD is equal to each other. In an exemplary embodiment, the light guide plate 223 may be rotated counterclockwise with reference to the center thereof, for example. Accordingly, the extending direction of the gap alignment line GAL marked on the light guide plate 223 may be parallel to the direction in which the plurality of gap alignment marks GAM is disposed in a line. The plurality of gap dimensions GD that are the shortest distances from the respective gap alignment marks GAM to the gap alignment line GAL may be equal to each other. Thus, the light source unit 221 and the light guide plate 223 may be accurately aligned, and the spaced distance between the light source unit 221 and the light guide plate 223 may be constantly maintained.

In an LCD device and a method for manufacturing the same according to a conventional art, a plurality of gap alignment marks is not respectively marked on a plurality of light sources of a light source unit, and a gap alignment line is not marked along an edge of a top surface of a light guide plate. Accordingly, a plurality of gap dimensions that are shortest distance from the respective gap alignment marks to the gap alignment line is measured. When the plurality of gap dimensions is different from each other, the positions of the light guide plate and the light source unit cannot be changed such that the plurality of gap dimensions is equal to each other. The spaced distance between the light guide plate and the light source unit may not be constant from one end to the other end of the light source unit, and one surface of the light guide plate may be inclined with respect to the extending direction of the light source unit. Therefore, a damage such as a crack due to collision with the light source unit may occur at a portion of the light guide plate, which is relatively close to the light source unit. The portion of the light guide plate, which is relatively close to the light guide plate, may be deformed due to heat generated by the plurality of light sources. When the spaced distances from the respective light sources to the light guide plate are different from each other, amounts of light incident onto the light guide plate are different from each other, and therefore, the light efficiency of the LCD device may be deteriorated.

In the LCD device 200 and the method according to the another exemplary embodiment of the invention, the plurality of gap alignment marks GAM is respectively marked on the top surfaces of the plurality of light sources 221b, and the gap alignment line GAL is marked along an edge of the light guide plate 223 on the top surface of the light guide plate 223. Positions of the plurality of gap alignment marks GAM and the gap alignment line GAL are detected, and a plurality of gap dimensions GD that are shortest distances from the respective gap alignment marks GAM to the gap alignment line GAL is calculated based on the detected positions. When the plurality of gap dimensions GD is different from each other, the positions of the light guide plate 223 and the light source unit 221 are changed such that the plurality of gap dimensions GD is equal to each other. Thus, the light guide plate 223 and the light source unit 221 may be accurately aligned. Accordingly, the spaced distances between the respective light sources 221b and the light guide plate 223 are equal to each other, and are adjusted within a specific dimensional range, so that the LCD device 200 may be manufacture. Thus, occurrence of a damage such as a crack in the light guide plate 223 due to physical impact between the light guide plate 223 and the light guide plate 221 may be reduced. Further, the spaced distances between the light guide plate 223 and the respective light sources 221b of the light source unit 221 are maintained within the specific dimensional range to be equal to each other, so that damage of the light guide plate 223 due to heat generated from each of the plurality of light sources 221b may be reduced. Furthermore, the amount of light incident onto the light guide plate 223 from each of the plurality of light sources 221b may be constant, and accordingly, the thermal efficiency of the light guide plate 223 and the LCD device 200 may be improved.

According to the invention, the alignment accuracy of several components of the LCD device may be improved, and the reliability of the LCD device may be improved.

Exemplary embodiments are disclosed herein, and although specific terms are employed, they are used and are to be interpreted in a generic and descriptive sense only and not for purpose of limitation. In some instances, as would be apparent to one of ordinary skill in the art as of the filing of the application, features, characteristics, and/or elements described in connection with a particular embodiment may be used singly or in combination with features, characteristics, and/or elements described in connection with other exemplary embodiments unless otherwise specifically indicated. Accordingly, it will be understood by those of skill in the art that various changes in form and details may be made without departing from the spirit and scope of the invention as set forth in the following claims.

What is claimed is:

1. A liquid crystal display device comprising:
a backlight unit including a reflective plate, a light guide plate, and an optical sheet, which are sequentially stacked therein; and
a liquid crystal display panel disposed on the backlight unit, the liquid crystal display panel including a display area and a non-display area surrounding the display area,
wherein a plurality of alignment marks is marked in the display area on a top surface of at least one of the reflective plate, the light guide plate, the optical sheet, and the liquid crystal display panel.

2. The liquid crystal display device of claim 1, wherein a number of the plurality of alignment marks marked on the top surface of the at least one of the reflective plate, the light guide plate, the optical sheet, and the liquid crystal display panel is four, and the plurality of alignment marks is disposed adjacent to respective vertices of the top surface.

3. The liquid crystal display device of claim 2, wherein a plurality of first alignment marks is marked on a top surface of one of the reflective plate, the light guide plate, the optical sheet, and the liquid crystal display panel, and a plurality of second alignment marks is marked on a top surface of another one of the reflective plate, the light guide plate, the optical sheet, and the liquid crystal display panel,
wherein two diagonal lines connecting the plurality of first alignment lines and two diagonal lines connecting the plurality of second alignment lines overlap with each other.

4. The liquid crystal display device of claim 3, wherein an intersecting point of the two diagonal lines connecting the plurality of first alignment marks and an intersecting point of the two diagonal lines connecting the plurality of second alignment marks overlap with each other.

5. The liquid crystal display device of claim 1, wherein the plurality of alignment marks includes a fluorescent material.

6. The liquid crystal display device of claim 5, wherein the plurality of alignment marks is viewed by light having a wavelength of no less than about 10 nanometers and no more than about 400 nanometers.

7. The liquid crystal display device of claim 1, wherein the thickness of each of the plurality of align marks is about 20 micrometers or less.

8. The liquid crystal display device of claim 1, further comprising a light source unit disposed adjacent to a side surface of the light guide plate, the light source unit including a plurality of light sources,
wherein a gap alignment line is marked along an edge of the top surface of the light guide plate, which is adjacent to the light source unit,
wherein a plurality of gap alignment marks is respectively marked on top surfaces of the plurality of light sources.

9. The liquid crystal display device of claim 8, wherein shortest distances between the respective gap alignment marks and the gap alignment line are equal to each other.

10. The liquid crystal display device of claim 1, further comprising:
a lower cover surrounding bottom and side surfaces of the backlight unit, the lower cover including a top surface on which the plurality of alignment marks is marked in the display area; and
an intermediate cover surrounding a portion of the top surface of the backlight unit and a side surface of the lower cover, the intermediate cover including a top surface on which the plurality of alignment marks is marked in the non-display area.

11. The liquid crystal display device of claim 1, wherein edges of the reflective plate, the light guide plate, and the optical sheet have a linear shape.

12. The liquid crystal display device of claim 1, wherein the optical sheet includes a diffusion sheet, a prism sheet, and an external light reflection preventing sheet, which are sequentially stacked therein.

13. A method for manufacturing a liquid crystal display device, the method comprising:
detecting positions of diagonal lines connecting a plurality of first alignment marks marked in one of a reflective plate, a light guide plate, an optical sheet, and a liquid crystal display panel including a display area and a non-display area surrounding the display area, and positions of diagonal lines connecting a plurality of second alignment marks marked in another one of the reflective plate, the light guide plate, the optical sheet, and the liquid crystal display panel;
aligning the one and the another one such that an intersecting point of the diagonal lines connecting the plurality of first alignment marks and an intersecting point of the diagonal lines connecting the plurality of second alignment marks overlap with each other; and
adjusting degrees of inclination of the one and the another one such that the diagonal lines connecting the plurality of first alignment marks and the diagonal lines connecting the plurality of second alignment marks overlap with each other.

14. The method of claim 13, wherein each of the plurality of first alignment marks and the plurality of second alignment marks are marked to overlap with the display area.

15. The method of claim 13, wherein the detecting the positions of the diagonal lines connecting the plurality of first alignment marks and the positions of the diagonal lines connecting the plurality of second alignment marks includes:
detecting positions of the plurality of first alignment marks of which a number is four, which are respectively disposed adjacent to four vertices of a top surface of the one;
detecting positions of two diagonal lines connecting the plurality of first alignment marks, based on the positions of the plurality of first alignment marks;
detecting positions of the plurality of second alignment marks of which a number is four, which are respectively disposed adjacent to four vertices of a top surface of the another one; and
detecting positions of two diagonal lines connecting the plurality of second alignment marks, based on the positions of the plurality of second alignment marks.

16. The method of claim 13, wherein the plurality of first alignment marks and the plurality of second alignment marks include a material which absorbs ultraviolet light and emits visible light.

17. The method of claim 13, further comprising:
detecting a gap alignment line marked along an edge of a top surface of the light guide plate, which is adjacent to a light source unit and a plurality of gap alignment marks respectively marked on top surfaces of a plurality of light sources of the light source unit;
calculating a plurality of gap dimensions which are shortest distances between the respective gap alignment marks and the gap alignment line; and
when the plurality of gap dimensions is different from each other, changing positions of the light guide plate and the light source unit such that the plurality of gap dimensions is equal to each other.

18. The method of claim 17, wherein the detecting the gap alignment line is performed using a line scan camera.

19. The method of claim 13, further comprising:
forming a lower cover surrounding bottom and side surfaces of the reflective plate, the light guide plate, and the optical sheet, the lower cover including a surface on which the reflective plate is disposed,
wherein a plurality of third alignment marks overlapping with the display area is marked on the surface; and
forming an intermediate cover in contact with a portion of a top surface of the optical sheet and a side surface of the lower cover, the intermediate cover including a top surface on which a plurality of fourth alignment marks overlapping with the non-display area is marked.
